(19) United States
(12) Patent Application Publication
(10) Pub. No.: US 2004/0120619 A1
(43) Pub. Date: Jun. 24, 2004

(54) Independent rotational supportive pad with use of flat bearing ring plate for CRT/TFT-LCD/PDP television monitor, computer monitor, stereo speaker, laptop computers and dinner dishes

(76) Inventor: Dong-Yeh Chai, Encintas, CA (US)

Correspondence Address: Mr. Dong-Yeh Chai, 4F.2, No 33, Sec. 4, Renai Rd.,, Daan Chiu, Taipei, 106, TW

(21) Appl. No.: 10/321,383

(22) Filed: Dec. 18, 2002

(51) Int. Cl. F16C 17/04

(52) U.S. Cl. 384/420

(57) ABSTRACT

This invention is an independent rotary supportive pad with the use of the “Flat Bearing” ring plate. The “pad” is constructed by having the “Flat Bearing” ring plate to be place between bi-planar surface. When the “pad” that is directly underneath heavy object such as television, computer monitor, stereo speaker, laptop computer or dining dishes. The pad replaces function of a television turntable or rotary table that acts, not only as a cushion between the planar surfaces of the base of the television to the planar surface of table or desk, but also allows revolving motion to take place with minimum increase in vertical height. In theory, the rotational supportive pad with “Flat Bearing” ring plate construction do not have a limit in width as long as the construction of the bearing plate follows the alternating rotational direction in each of the rings.

### BACKGROUND OF THE INVENTION

This device is related to bi-planar support pad and more specifically a rotational plate for heavy article like television such as the Lazy-Susan. Lazy-Susan has existed for many years and it has evolved into a variety of forms. Current horizontal rotational plate for home appliance that allows changing of viewing position in respect to its x-axis such as television turntable are mostly constructed by an upper and lower plate with circular grooves in between the plates filled with bearings. These bearings roll freely between the grooves to minimize friction so the two plates may rotate independently. Other rotary table device uses steel ball bearing on plastic or steel retainers positioned in between plates to ease friction. This apparatus is placed on top of desk or table to execute rotational movement. However, these ball bearing types apparatuses have number of drawbacks in the design.

These ball bearing apparatuses are usually large, heavy and bulky. The reason for the bulkiness is due to the fact that two separate top and bottom plates and also the bearing retainer is required to execute rotational movement. The amount of required parts involved inherently makes the conventional rotary table extremely bulky.

Moreover, if the intended rotational object is rather heavy, then the ball bearing, bearing retainer structure and supportive plate needs to increase structural integrity to accommodate the weight of intended rotational object. Structural integrity usually results in larger bearings, bearing retainer, as well as large and thicker supportive plate. In order to support heavy objects, the rotary device needs to be built bigger. This increase in size occupies more shelves, cabinet and table space and is visually unsightly for the user.

Additional disadvantage of using existing ball bearing base rotational device is that wear and tear will result from use. Wear and tear is especially pronounced if the bearing retainer and the ball bearing are made from materials with different densities. For example, if the bearing retainer structure is made of plastic, while the ball bearing is made of steel, the repeated spinning action will wear out the plastic retainer. Also, if the weight of intended rotating object was over the limit of bearing retainer's original design specification, then the higher density steel ball bearing will crush lower density retainer. Moreover, the bearing retainer may damage the table or desk if the article place on top of the rotary solution is too heavy.

With advancement of materials technology in plastics, polymer or plastic bearing plate may be used to replace the function of the ball bearing in television turntables. The need of having a circular track is eliminated. Ball bearing is also replaced with plastic bearing pad. Plastic bearing plate is still required to have an apparatus that can provide a reference center to conduct rotating moment. The solution to the conventional ball bearing television turntable is to introduce an upper and lower planar plate with a hole in the center for rotational reference. The upper and lower planar plate clamps together with a bearing pad in the middle. As a result, vertical height of the rotary solution registers at a bit over one centimeter only.

### BRIEF SUMMARY OF THE INVENTION

The general idea of this invention is to provide a “thin” rotary solution for articles such as CRT/LCD/PDP monitors, laptop computer, stereo speaker, and dining dish.

This invention provides simplicity, compactness, lightweight, reliable and resilience bi-planar surface rotary pad.

This invention uses successive concentric ring plates that I called “Flat Bearing” ring plate to provide rotary movement for the rotational supportive pad. The “Flat Bearing” ring plate uses grooves and rail track that act not only prevent ring plates and disc from detaching when sliding against each other, but also provide rotary guide when rotating opposite or independent to each other. With “Flat Bearing” ring plate deploy in-between bi-planar surface to be secure with adhesive and friction reduction material to specify surface of ring plates and disc, the bi-planar surface is then capable of conduct independent rotational movement in reference to the surface that is on the opposite side of “Flat Bearing” ring plate. The advantage of rotational supportive pad with the “Flat Bearing” ring plate eliminates the use of ball bearing, bearing retainer, screws or nuts to conduct rotational movement. Therefore, it is more economical and practical to manufacture. The elimination of screw, nuts, ball bearing and bearing retainer allows the plate to have unlimited width to accommodate various sizes of intended rotational object to be placed on top of the rotational supportive pad in reference to a planar base. In addition, the advantage of the concentric bearing rings plates is that the “Flat Bearing” rings plate can be constructed by the use of different materials as long as adhesive or other means of securing “Flat Bearing” ring plate and friction reduction material is apply in-between the specify contact surfaces of the ring plates and the planar surface.

### BRIEF DESCRIPTION OF THE SEVERAL VIEWS OF THE DRAWING

FIG. 1. is the perspective view of the apparatus when view from the top showing center disc 1, 1^{st} outer ring 2, 2^{nd} outer ring 3 and 3^{rd} outer ring 4.

FIG. 2. is the perspective view of the apparatus when view from the bottom showing center disc 1, 1^{st} outer ring 2, 2^{nd} outer ring 3 and 3^{rd} outer ring 4.

FIG. 3 is the side view the rotational supportive pad apparatus with silicon 37, flat bearing ring plate 39, upper plate 38, lower plate 40 and silicon 37.

FIG. 4 is the perspective view for constructing the Center Disc with disc plate 5, disc plate 6 and disc plate 7.

FIG. 5 is the cross section view of the Center Disc showing built-in groove 8.

FIG. 6 is the perspective view for constructing the First Outer Ring showing concentric ring plate 9, concentric ring plate 10 and concentric ring plate 11.

FIG. 7 is the cross section view of the First Outer Ring showing rail track 12 and rail track 13.

FIG. 8 is the perspective view for constructing the Second Outer Ring showing concentric ring plate 14, concentric ring plate 15 and concentric ring plate 16.

FIG. 9 is the cross section view of the Second Outer Ring showing built-in groove 17 and built-in groove 18.

FIG. 10 is the perspective view for constructing the Third Outer Ring showing concentric ring plate 19, concentric ring plate 20 and concentric ring plate 21.

FIG. 11 is the cross section view of the Third Outer Ring showing rail track 22.

FIG. 12 is the cross-section view of the flat bearing ring plate. (After installing the center disc 33, 1^{st} outer ring 34, 2^{nd} outer ring 35 and 3^{rd} outer ring 36 together.)

FIG. 13 is the perspective view of flat bearing ring plate viewing from the top indicated with number 23, 25, 27, 29 to specify which surfaces of the center disc and outer rings to be applied with adhesive and friction reduction material.

FIG. 14 is the perspective view of flat bearing ring plate viewing from the bottom indicated with number 24, 26, 28, 30 to specify which surfaces of center disc and outer rings to apply with adhesive and friction reduction material.

FIG. 15 is the perspective view of the flat bearing ring plate 32 with top plate 31 and bottom plate 32 viewing from the top.

FIG. 16 is the perspective view on illustrating procedures to construct the flat bearing ring plate in sequence from step 1 to step 12.

FIG. 17 is the perspective view which illustrate the use of rotational support pad 53 place underneath CRT television 54 or LCD/PDP monitor 55

### DETAIL DESCRIPTION OF THE INVENTION

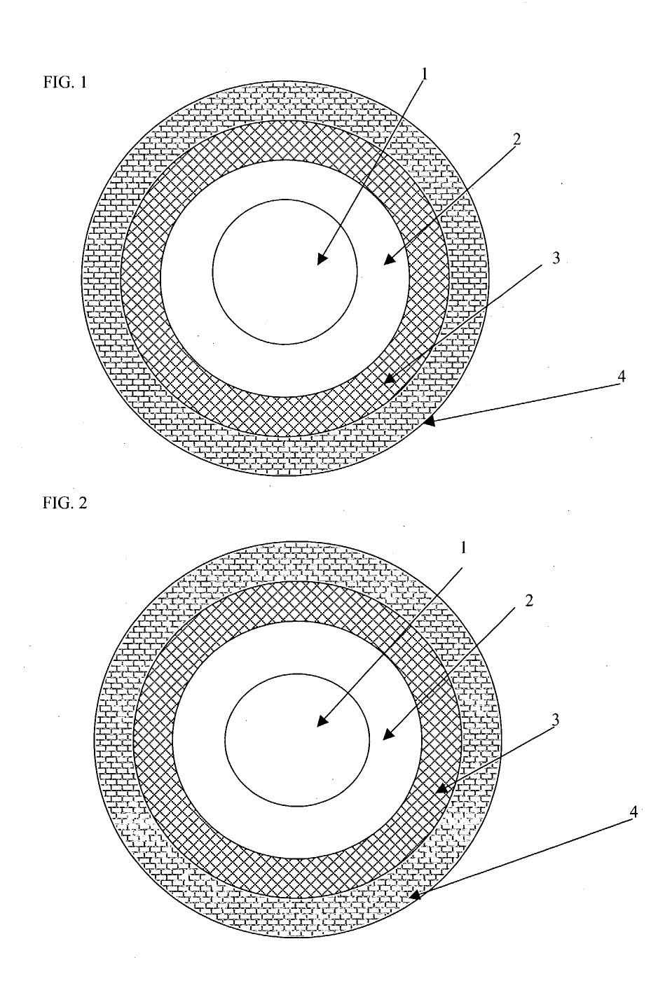

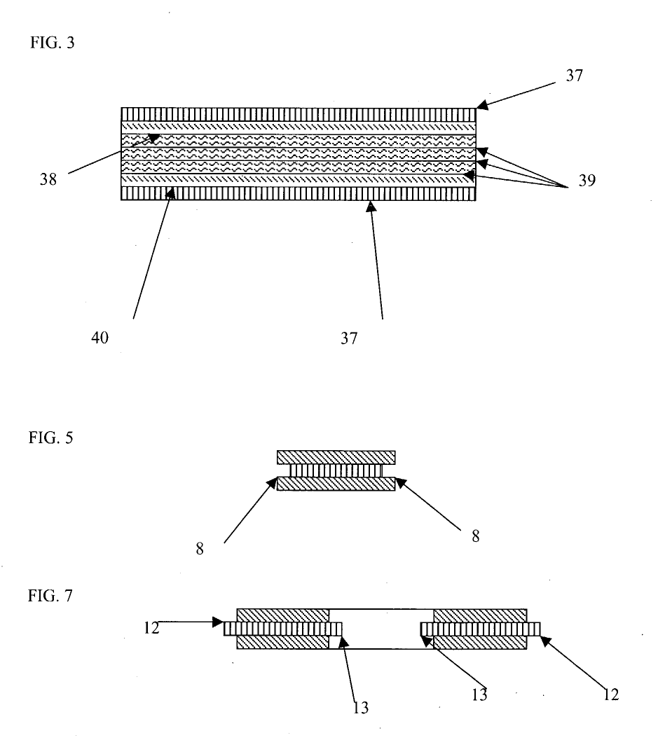

Critical elements of rotational supporting pad are the constructions of the “Flat Bearing” ring plate (FIG. 1). The “Flat Bearing” ring plate is intended to replace the use of ball bearing and bearing retainer in Lazy-Susan, T.V. turntable, and rotary table that is commercially available in the market currently. Also, the flat bearing ring plate with its successive ring arrangement, that mimics tree's age ring, eliminates the use of screw or nuts that act as a center for rotary device that does not use ball bearing and circular track. The elimination of ball bearing and the screws reduces the overall vertical heights of the plural planar rotational supportive apparatus.

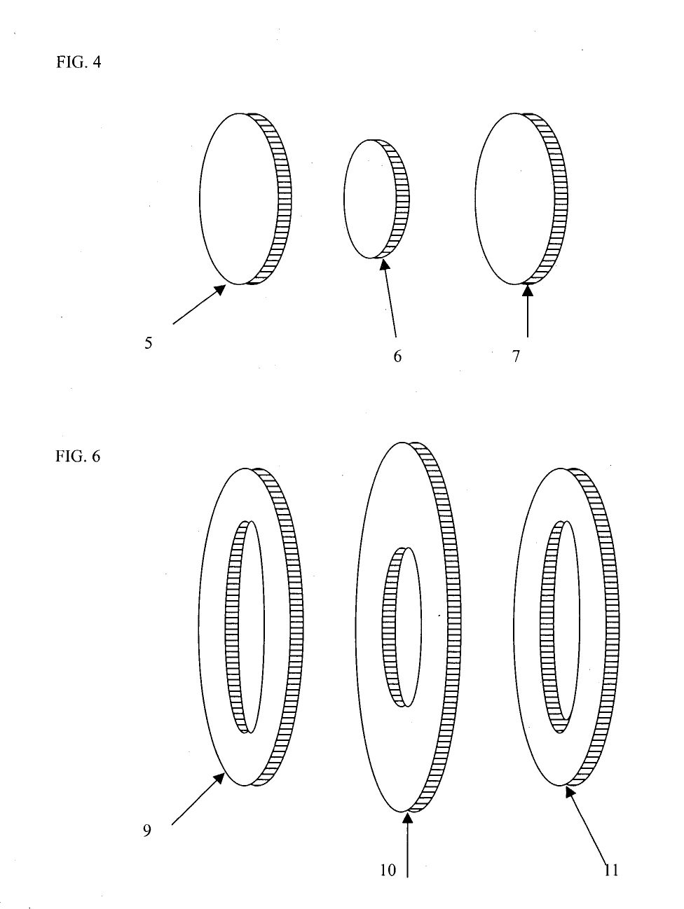

The creation of the “Flat Bearing” ring plate involves constructing a center disc 1, and concentric rings plates consist of 1st outer ring 2, 2^{nd} outer ring 3 and 3rd outer ring 4 (FIG. 1). The “Flat Bearing” plate starts with the building of the center disc. The center disc is build by three disc plates 5, 6 and 7 (FIG. 4) with thickness greater than 0.01 cm and bond together with adhesive applied to both side of disc plate 6. The reason for using three disc plates is to create a center disc with built-in groove 8 (FIG. 5). By having plate disc 6 (FIG. 4) cut with short radius than disc plate 5 and 7 creates sliding groove 8 for 1^{st} outer ring 2 to rotate against with. In this sample, disc 6 is cut with a radius 0.1 cm less than disc plate 5 and 7. In this sample, disc plate 5 and 7 is cut with a radius of 2 cm, while disc plate 6 is cut with 1.9 cm. Once the three plates are bonded together with center of the circular plates align to each other, the center disc 1 will have a built-in groove 8 in it, which can be seen with cross section view (FIG. 5).

After creating the center disc 1 with a build-in groove 8, the second part for constructing “Flat Bearing” plate is the 1st outer ring plate 2 (FIG. 1). The construction 1^{st} outer ring plate involves the formation of concentric ring plate 9, 10 and 11 (FIG. 6) with the thickness consistent with the disc 5, 6 and 7 (FIG. 4) bonded with adhesive applied to bottom side of concentric ring plate 9 and top side of concentric ring plate 10. The radius to create inner circumference for the concentric ring plate 9, 10 and 11 will be same radius used to create disc 5, 6 and 7. Outer circumference of ring plate 9, 10 and 11 must also be cut out to serve as guiding track for 2^{nd} outer ring plate 3 (FIG. 1) to rotate against with. The outer circumference for concentric ring plate 9, 10 and 11 is cut with a radius that is greater than the radius used to create disc 5, 6 and 7. In this sample, the outer circumference for concentric ring plate 9 and 11 is cut by a radius of 4 cm, while concentric ring plate 10 (FIG. 6) has an outer circumference cut with a radius 0.1 cm greater than ring plate 9 and 11. When concentric ring plate 9, 10 and 11 bonds together, it will create rail track 13 (FIG. 7) from concentric ring plate 10 corresponding to disc 6's shorter radius. Also, with concentric ring plate 10 has its outer circumference cut with a radius 0.1 cm greater than the radius used to create outer circumference of concentric ring plate 9 and 11, this forms an extended section of ring plate in respect to ring plate 9 and 11. When concentric ring plate 9, 10 and 11 are glued together with adhesive to from 1^{st} outer ring 2 (FIG. 7), the extended section of ring plate from outer circumference of concentric ring plate 10 will serve as a rail track 12 (FIG. 7) for built-in grooves 18 of the 2^{nd} outer ring 3 (FIG. 9) to slide against with. A cross section view of the 1^{st} outer ring (FIG. 7) can depict the extension of concentric ring plate 10 in its inner and outer circumference by 0.1 cm in respect to ring plate 9 and 11 to form rail track 12 and 13 for rotation.

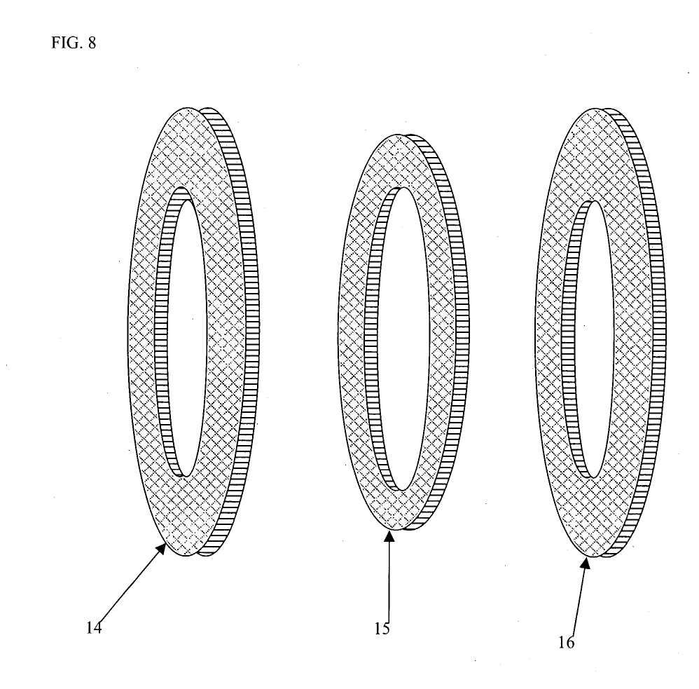

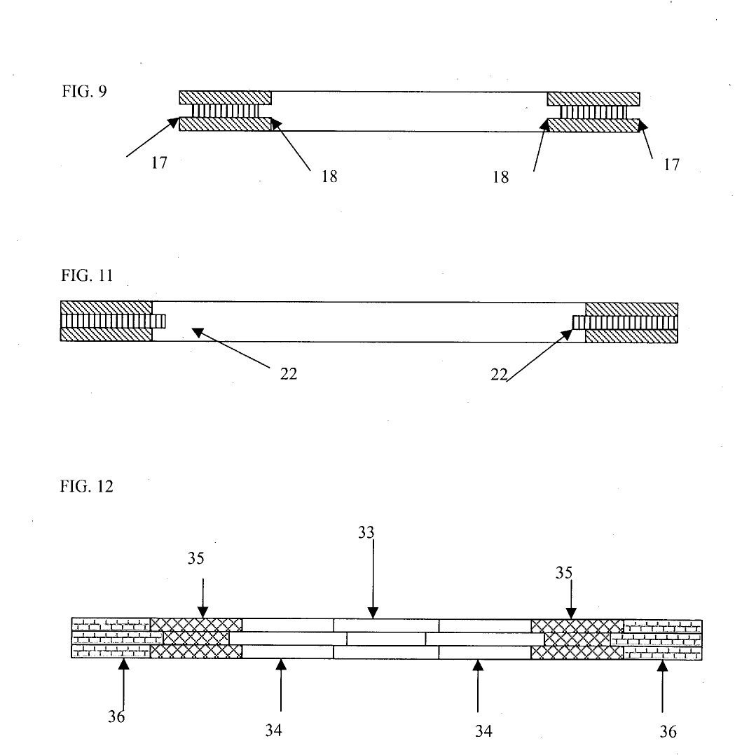

The third part of construction of “Flat Bearing” plate is the 2^{nd} outer ring 3 (FIG. 1). The 2^{nd} outer ring is formed by concentric ring plate 14, 15 and 16 (FIG. 8) bonded by adhesive applied to both side of concentric ring plate 15 with thickness consistent to concentric ring plate 9, 10 and 11. The inner circumference of concentric ring plate 14, 15 and 16 is created with radius used to cut outer circumference of concentric ring plate 9, 10 and 11. The outer circumference of concentric ring plate 14, 15 and 16 is cut with radius greater than radius use to create its inner circumference. In this sample, the outer circumference of concentric ring plate 14 and 16 is cut by radius of 6 cm, but concentric ring plate 15 is cut with radius 0.1 cm shorter. Concentric ring plate 15 which corresponds to concentric ring plate 10 that has inner circumference cut with short radius to form built-in groove 18 (FIG. 9) when bond in-between concentric ring plate 14 and 16 (FIG. 8) to form 2^{nd} outer ring 3. When Concentric ring plate 14 and 16 bond with concentric ring plate 15, its outer circumference is cut with radius shorter than ring plate 14 and 16 by 0.1 cm to create built-in groove 17 (FIG. 9) for rail track 22 (FIG. 11) from 3^{rd} outer ring 4 to slide against with. Built-in groove 17 and 18 can be viewed by cross section view of 2^{nd} outer ring (FIG. 9).

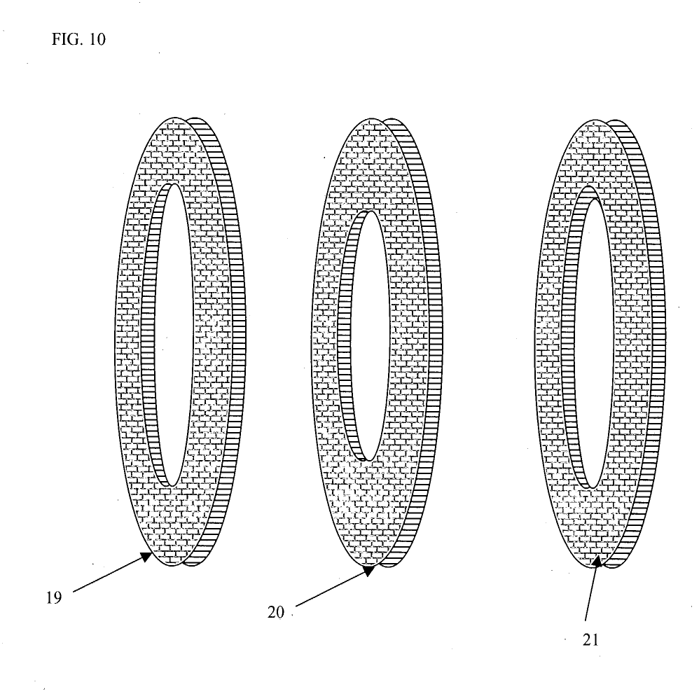

Last part of constructing flat bearing plate is the 3^{rd} outer ring 4 (FIG. 1). The formation of the 3^{rd} outer ring is by bonding concentric ring plate 19, 20 and 21 (FIG. 10). Thickness of concentric ring plate 19, 20 and 21 has to be consistent with concentric ring plate 14, 15 and 16. The radius use to form inner circumference of concentric ring plate 19, 20 and 21 is the same radius use to form outer radius of concentric ring plate 14, 15 and 16. As a result, ring plate 20 that correspond to ring plate 15 will have an inner circumference cut with a radius shorter than ring 19 and 21 by 0.1 cm. Outer circumference of concentric ring plate 19, 20 and 21 is cut with the same radius but greater than its inner circumference. In this sample, the outer circumference of concentric ring plate 19, 20 and 21 is cut by a radius of 7.5. When combining concentric ring plate 19, 20 and 21 (FIG. 10) by adhesive apply to bottom side of concentric ring plate 19 and top side of concentric ring plate 21, rail track 22 (FIG. 11) appears as the inner circumference of concentric ring plate 20 cut with shorter radius than concentric ring plate 19 and 20. The extended ring plate coming from concentric ring plate 20 is then used to slide against built-in groove 17 of 2^{nd} outer ring (FIG. 9). The rail track 22 can be viewed by cross-section view of 3^{rd} outer ring 4 (FIG. 11).

Larger version of the “Flat Bearing” ring plate can be constructed with wider radius that is use to form the center disc plates and the concentric ring plates.

After finish constructing the center disc, 1^{st}, 2^{nd} and 3^{rd} outer rings, the circumferences of disc and the concentric ring plate have to be sanded to provide smooth rotational surface.

To assemble a “Flat Bearing” ring plate is to take the rail track 13 (FIG. 7) from 1^{st} outer ring 2 insert into built-in groove 8 (FIG. 5) of the center disc 1. After inserting rail track 13 from 1^{st} outer ring 2 into built-in groove 8 of center disc 1, take 2^{nd} outer ring with built-in groove 18 (FIG. 9) place it to 1^{st} outer ring's rail track 12 (FIG. 7). With 2^{nd} outer ring attach to 1^{st} outer ring and 1^{st} outer ring attached to the center disc, the last step is to take rail track 22 (FIG. 11) of 3^{rd} outer ring 4 insert into built-in groove 17 (FIG. 9) of 2^{nd} outer ring.

All of the attachment process mention above does not involve adhesive. The locking the rail track with build-in groove to each of the outer rings and the center disc can perform rotational movement independent to each other. Hence, this is completion of the “Flat Bearing” ring plate.

If the bearing plate is made by ridged material such as ceramic than it is impossible to insert the rail track 13 from 1^{st} outer ring into built-in groove 8 of center disc, therefore assembly procedure is changed to the following.

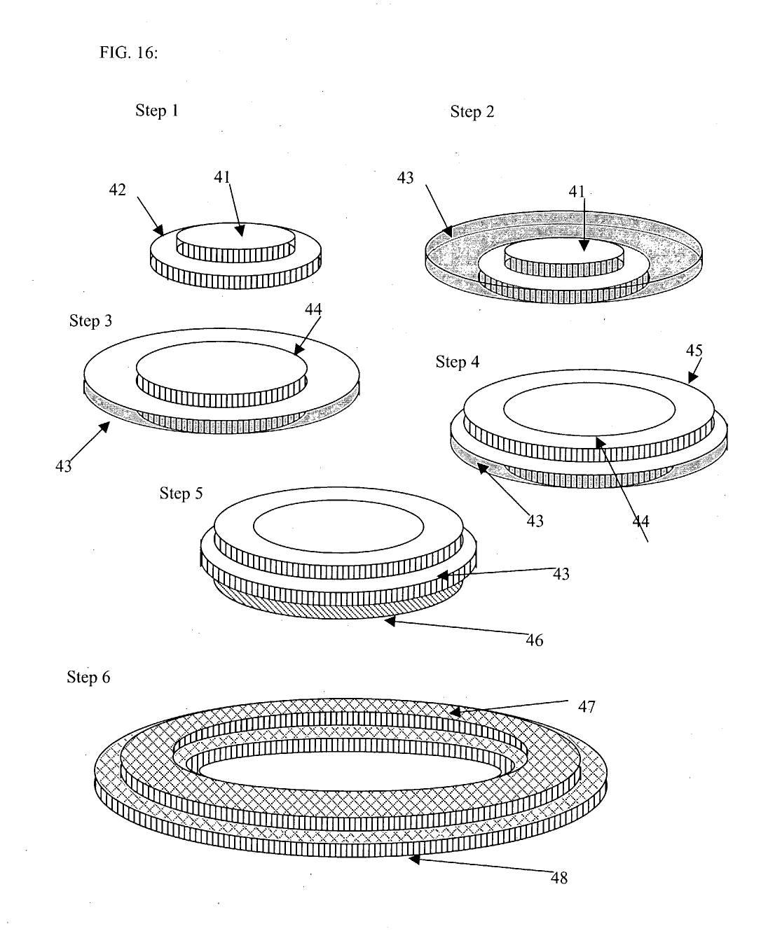

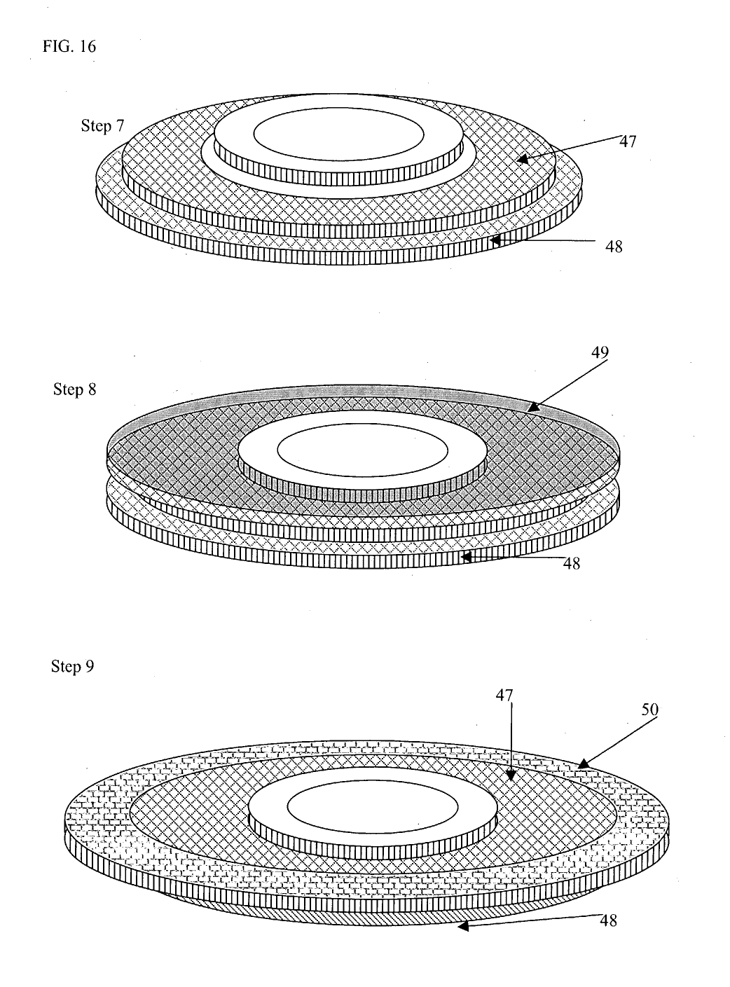

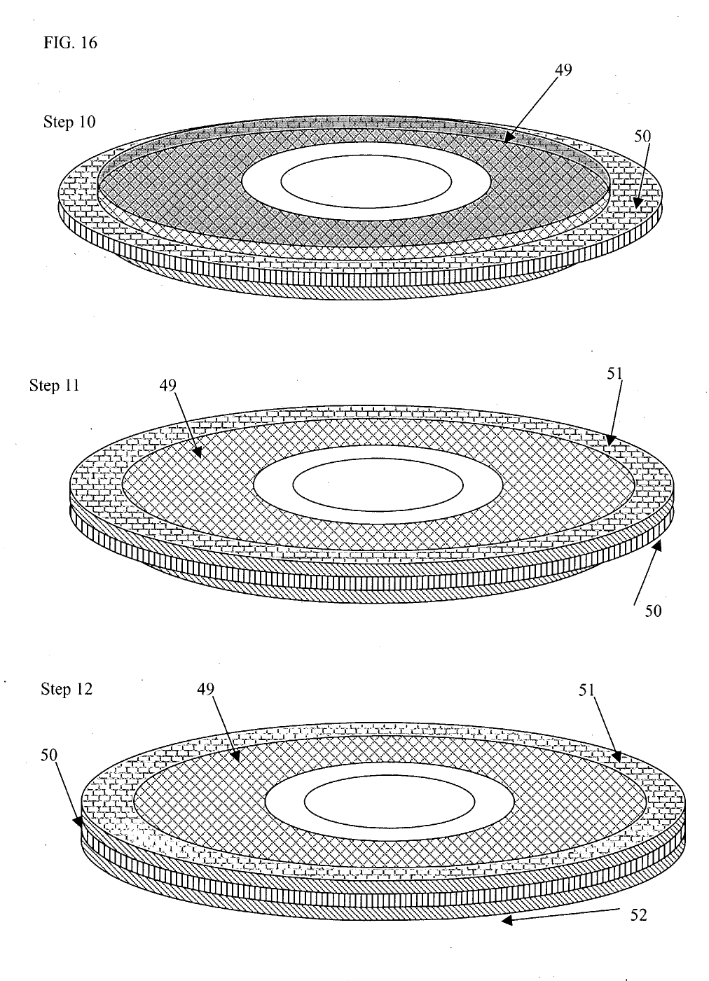

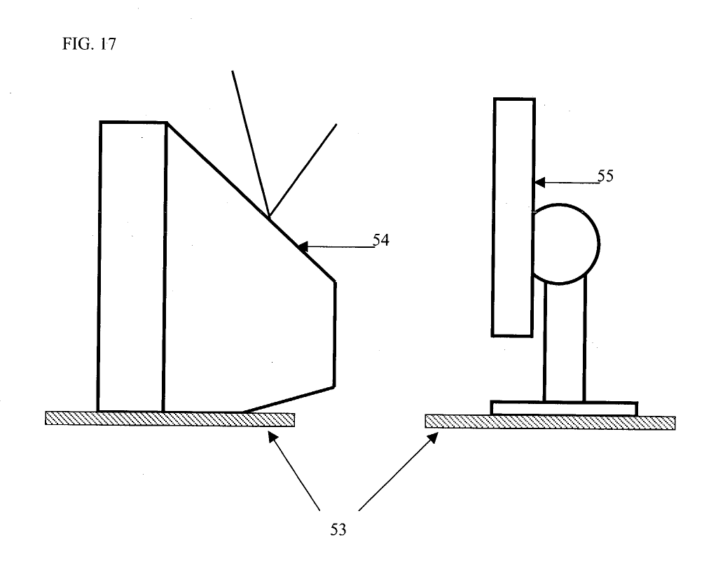

Apply adhesive to the bottom of the disc 41 (Step 1/FIG. 16) to bond together with disc 42 (FIG. 16) and take concentric ring plate 43 and placed it on top of disc 42 with disc 41 inside of concentric ring plate 43 (Step 2/FIG. 16). With disc 41 fitted into concentric ring plate 43 then apply top of disc 41 with adhesive and place disc 44 on top of disc 41 and sandwiching concentric ring plate 43 (Step 3/FIG. 16). With concentric ring plate 43 attach to center disc 1 (Step 3/FIG. 16) then apply bottom of concentric ring plate 45 with adhesive and take concentric ring plate 45 and place on top of concentric ring plate 43 with disc 44 fitted inside of concentric ring plate 45 (Step 4/FIG. 1). After concentric ring plate 45 is bonded with concentric ring plate 43 with adhesive and disc 44 fitted inside of concentric ring plate 45 (FIG. 16), then apply adhesive to the top of concentric ring plate 46 to bond with concentric ring plate 43 with disc 42 fitted inside of concentric ring plate 46 (Step 5/FIG. 16). As a result, center disc 1 and 1^{st} outer ring 2 (Step 5/FIG. 16) are formed.

To finish the construction of flat bearing ring plate, take concentric ring plate 47 (FIG. 16) and apply it with adhesive to the bottom and bond it with concentric ring plate 48 (Step 6/FIG. 16). After concentric ring plate 48 is bonded with concentric ring plate 47, then take this unit of ring plates to combine with center disc 1 and 1^{st} outer ring 2 from fitting concentric ring plate 47 and 48 unit into concentric ring plate 43 and 46 from the bottom (Step 7/FIG. 16). Before bonding concentric ring plate 49 to concentric ring plate 47 (which looks like step 8 of FIG. 16), take concentric ring plate 50 of 3^{rd} outer ring to be fitted with concentric ring plate 47 (Step 9/FIG. 16). With concentric ring plate 50 from 3^{rd} outer ring in place, than apply adhesive to the top of concentric ring plate 47 (FIG. 8) to bond with concentric ring plate 49 (step 10/FIG. 16) and sandwiching concentric ring plate 50 (step 10/FIG. 16) in the process. The last step of finishing flat bearing ring plate is to apply adhesive to both top concentric ring plate 52 and bottom of concentric ring plate 51 to sandwich concentric ring plate 50 (Step 11/FIG. 10) in the middle.

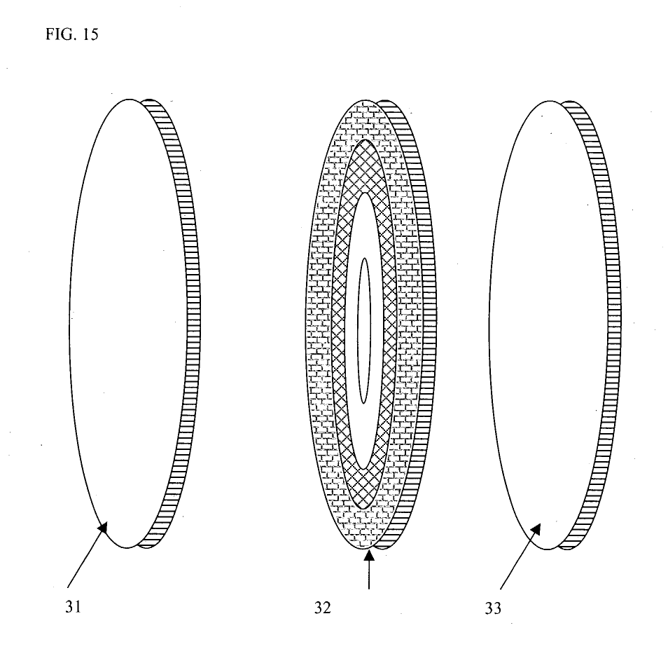

To create a horizontal rotational supportive pad is taking the finished flat bearing ring plate 33 (FIG. 15) place it in between plate 31 and plate 32 (FIG. 15) that has the same diameter of the bearing ring plate apparatus with top surface of plate 31 and bottom surface of plate 32 coated with or attach with silicon, rubber or other form of slip-resistant cushioning materials. However, there is a sequence of applying adhesive and friction reduction material to the flat bearing ring plate 33 before attaching to non silicon, rubber or other slip-resistant cushioning material coated side of surface of plate 31 and plate 32 is needed to allow the final product to rotate properly.

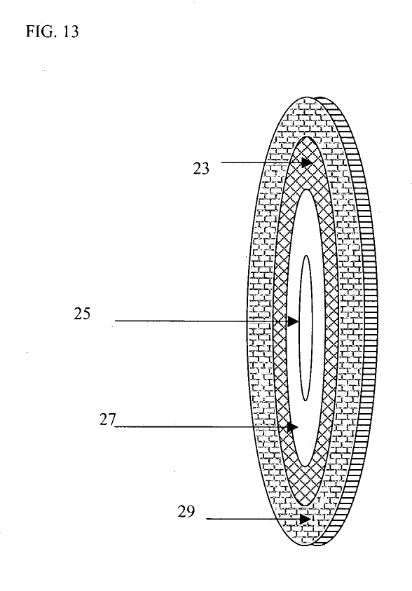

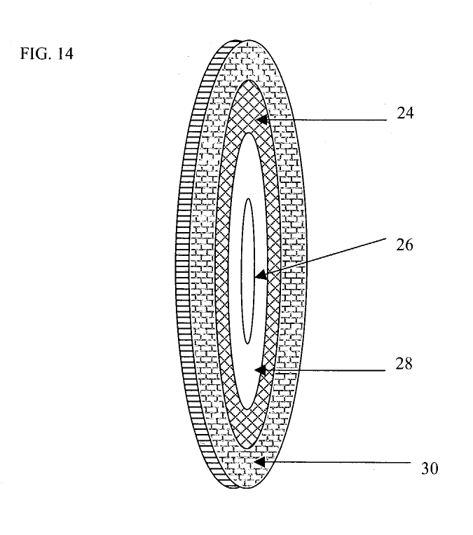

First, taking the flat bearing ring plate to view it from the side that is horizontal to the ground to determine the orientation of the top and bottom side of the bearing ring plate. Once the top and bottom side of the bearing ring plate is determined, then apply the adhesive to the bearing ring plate by starting from the top side of center disc 25 (FIG. 13). After applying adhesive to top of center disc 25, apply the friction reduction material to the bottom side of center disc 26 (FIG. 14). When adhesive and friction reduction material is applied to the center disc, then move on to apply the adhesive to the bottom side of 1^{st} outer ring 28 (FIG. 14) and apply the friction reduction material to the top side of 1^{st} outer ring 27 (FIG. 13). With 1^{st} outer ring applied with adhesive and friction reduction material application, then apply adhesive to top of 2^{nd} outer ring 23 (FIG. 13) and apply friction reduction material to bottom side of 2^{nd} outer ring 24 (FIG. 14). Finally, adhesive is applied to bottom side of 3^{rd} outer ring 30 (FIG. 14) and friction reduction material is applied to top side of 3^{rd} outer ring 29 (FIG. 13).

With adhesive and friction reduction material application apply to center disc, 1^{st} outer ring, 2^{nd} outer ring and 3^{rd} outer ring to form “Flat Bearing” ring plate 32 (FIG. 15). Take “Flat Bearing” ring plate 32 with adhesive and friction reduction material solution applied to both side to bond in-between plate 31 (FIG. 15) and plate 33 (FIG. 15) by using the side of surface that is not coated with silicon, rubber or other slip-resistant cushioning materials to form rotational supportive pad.

What I claim as the invention is:

1. “Flat bearing” ring plate, formed by incorporating a centers disc and number of concentric ring plates position in successive expanding configuration starting from the center of the plate that interlocks with each other with grooves on the outer circumference of the disc which rails and grooves to the external and internal of circumference of concentric ring plates, which resembles tree's age ring.

2. The “Flat Bearing” ring plate in accordance with claim 1 wherein materials with smooth planar surfaces like plastic, metal, ceramic, glass, carbon fiber, or paper or any improved material by future inventors can be use for constructing claim 1.

3. In accordance with claim 1 and claim 2, the “Flat Bearing” ring plate can be constructed with thickness greater than 0.1 cm.

4. In accordance with claim 1 and claim 2 with adhesive and friction reduction material apply to specified surfaces of “Flat Bearing” ring plate to bond in-between plastic, metal, ceramic, glass, carbon fiber, paper upper and lower plate or any improve material by future inventors with top and bottom surface of the plate coated with or attached with silicon, rubber or other forms of slip-resistant cushioning material to create bi-planar rotational supporting pad.

5. In accordance with claim 4, the upper and lower plate can be in different shape or sizes.

6. The rotational support pad in accordance with claim 4 can be place beneath objects such as CRT/LCD/PDP television, computer monitor, laptop computer and stereo speakers with planar surface and placed on top of flat horizontal planar base such as table, floor or desktop to conduct revolving movement.

7. The outward expansion of radius in claim 1 and of width in claim 4 to form enlarged rotational supportive pad can be place in the middle of round tables hosting dining dishes on top of the rotary supportive pad to serve the dishes conveniently to others sitting around the round table in a fashion similar to a Lazy-Susan.

8. In accordance of claim 1, the “Flat Bearing” ring plate can be attached directly in between any two objects with horizontal planar surface with adhesive or other means of securing “Flat Bearing” ring plate and friction reduction materials apply to specified surfaces of claim 1 and claim 2 to conduct independent rotational motion to the object that is on the opposite side of the claim 1 in reference to the axis of “Flat Bearing” ring plate.

9. Grooves and rail tracks in each of the successive concentric rings plates and the center disc in accordance of claim 1 creates interlocking mechanism that allows each of the concentric ring plates and the center disc that constitute the make up of “Flat Bearing” ring plate to rotate freely, without slipping or detaching from each other.

10. “Flat Bearing” ring plate in accordance to claim 1, claim 7 and claim 8 to conduct precise rotary motion without the use of screw/nut/washer type metal parts and or ball bearing embedded circular track structure as means to provide axis of rotational reference center for rotary motion

11. The “Flat Bearing” ring plate in accordance with claim 1 transfers weight of supporting object that rest on top of the rotational supportive pad in claim 4 to horizontal reference base without the use of bearing balls for rotational motion in respect to x-axis.

12. Use of different materials, colors, or graphic designs can be coated on the surface of the upper and lower plate of claim 4 to be come more appealing to different age or gender groups.
